(19) United States
(12) Patent Application Publication
(10) Pub. No.: US 2016/0205988 A1
(43) Pub. Date: Jul. 21, 2016

(54) REFRIGERATOR APPLIANCE AND METHOD FOR USE WITH SINGLE SERVE FLAVOR PODS

(71) Applicant: General Electric Company, Schenectady, NY (US)

(72) Inventors: Christopher Francis Bird, Louisville, KY (US); Bradley Nicholas Gilkey, Louisville, KY (US); Deepak Kumar Parida, Louisville, KY (US)

(21) Appl. No.: 14/599,684

(22) Filed: Jan. 19, 2015

(51) Int. Cl. A23L 2/56

(52) U.S. Cl. CPC A23L 2/56; A23V 2002/00

(57) ABSTRACT

A refrigerator appliance and a method for operating a refrigerator appliance are provided. The refrigerator appliance includes features for dispensing single serve beverages. The method include features for dispensing single serve beverages from refrigerator appliances after proper mixing or soaking of a substance in a single serve flavor pod.

### FIELD OF THE INVENTION

The present subject matter relates generally to refrigerator appliances, and more particularly for methods and apparatus for use of single serve flavor pods in refrigerator appliances.

### BACKGROUND OF THE INVENTION

Certain refrigerator appliances include a dispenser for directing ice from the refrigerator's ice maker and/or liquid water to the dispenser. A user can activate the dispenser to direct a flow of ice or liquid water into a cup or other container positioned within the dispenser. Liquid water directed to the dispenser is generally chilled or at an ambient temperature. However, certain refrigerator appliances can also include features for dispensing heated liquid water. The heated liquid water can be used to make certain beverages, such as coffee or tea.

In some cases, users may desire only a single serving of a beverage, such as, e.g., a hot beverage, and some refrigerator appliances may include a dispensing assembly with features for utilizing single serve flavor pods to dispense single serve beverages. Such flavor pods typically contain a substance for creating a beverage, such as, e.g., coffee, tea, hot chocolate, lemonade, or the like, when water, e.g., from a needle of the dispensing assembly, is passed through the flavor pod. However, the location of the substance within the single serve flavor pod can vary, e.g., for some flavor pods, the substance is contained near a top portion of the pod, but for other flavor pods, the substance is contained near a bottom portion of the pod. The flow path of the water from the needle and the location of the substance can affect the soaking of the substance, such as, e.g., coffee grounds, and/or mixing of the substance, such as, e.g., powdered chocolate or lemonade, with water. If the substance is not properly soaked or mixed with the water, the beverage quality may be poor, e.g., if the substance is not properly mixed with the water, much of the substance may remain within the single serve flavor pod instead of mixing with the water to form the beverage that is dispensed to a container such as, e.g., a cup placed beneath the dispenser.

Accordingly, an improved refrigerator appliance that includes features for dispensing single serve beverages would be desired. In particular, methods and apparatus for dispensing single serve beverages from refrigerator appliances after proper mixing or soaking of a substance in a single serve flavor pod would be advantageous.

### BRIEF DESCRIPTION OF THE INVENTION

The present invention provides a refrigerator appliance and method for operating a refrigerator appliance. The refrigerator appliance includes features for dispensing single serve beverages. The method include features for dispensing single serve beverages from refrigerator appliances after proper mixing or soaking of a substance in a single serve flavor pod. Additional aspects and advantages of the invention will be set forth in part in the following description, may be apparent from the description, or may be learned through practice of the invention.

In a first exemplary embodiment, a method for operating a refrigerator appliance is provided. The refrigerator appliance has a dispensing assembly for receipt of a housing for containing single serve flavor pods, each single serve flavor pod containing a substance for creating a beverage. The method includes the steps of: initiating a dispensing cycle; providing a liquid to a supply valve and a flow control device such that the liquid is output from the flow control device at a known flow rate; flowing the liquid to the single serve flavor pod; and providing a flow of air to the single serve flavor pod, wherein flowing the liquid and providing the flow of air soaks the substance in the single serve flavor pod with the liquid to create the beverage.

In a second exemplary embodiment, a method for operating a refrigerator appliance is provided. The refrigerator appliance has a dispensing assembly for receipt of a housing for containing single serve flavor pods, each single serve flavor pod containing a substance for creating a beverage. The method includes the steps of: initiating a dispensing cycle; providing a liquid to a first supply valve; providing the liquid to a second supply valve and a flow control device such that the liquid is output from the flow control device at a known flow rate; flowing the liquid from the first supply valve to the single serve flavor pod; and flowing the liquid from the flow control device to the single serve flavor pod, wherein flowing the liquid from the first supply valve and from the flow control device soaks the substance in the single serve flavor pod with the liquid to create the beverage.

In a third exemplary embodiment, a method for operating a refrigerator appliance is provided. The refrigerator appliance has a dispensing assembly for receipt of a housing for containing single serve flavor pods, each single serve flavor pod containing a substance for creating a beverage. The method includes the steps of: initiating a dispensing cycle; providing a liquid to a supply valve and a flow control device such that the liquid is output from the flow control device at a known flow rate; flowing the liquid from the flow control device to the single serve flavor pod; pausing the flow of the liquid for a predetermined time period tₚₐᵤₛₑ; and resuming the flow of liquid from the flow control device to the single serve flavor pod, wherein flowing the liquid from the flow control device, pausing the flow, and resuming the flow soaks the substance in the single serve flavor pod with the liquid to create the beverage.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front, elevation view of a refrigerator appliance according to an exemplary embodiment of the present subject matter.

FIG. 2 illustrates a dispensing assembly of the refrigerator appliance of FIG. 1 according to an exemplary embodiment of the present subject matter.

FIG. 3 provides a schematic view of the dispensing assembly of FIG. 2 according to an exemplary embodiment of the present subject matter.

FIG. 4 provides a schematic view of a single serve flavor pod of the dispensing assembly of FIG. 2 according to an exemplary embodiment of the present subject matter.

FIG. 5 provides a schematic view of the single serve flavor pod of FIG. 4 according to another exemplary embodiment of the present subject matter.

FIG. 6 provides a schematic view of the single serve flavor pod of FIG. 4 according to another exemplary embodiment of the present subject matter.

FIG. 7 provides a chart illustrating a method of operating a refrigerator appliance according to an exemplary embodiment of the present subject matter.

FIG. 8 provides a chart illustrating a method of operating a refrigerator appliance according to another exemplary embodiment of the present subject matter.

FIG. 9 provides a chart illustrating a method of operating a refrigerator appliance according to another exemplary embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

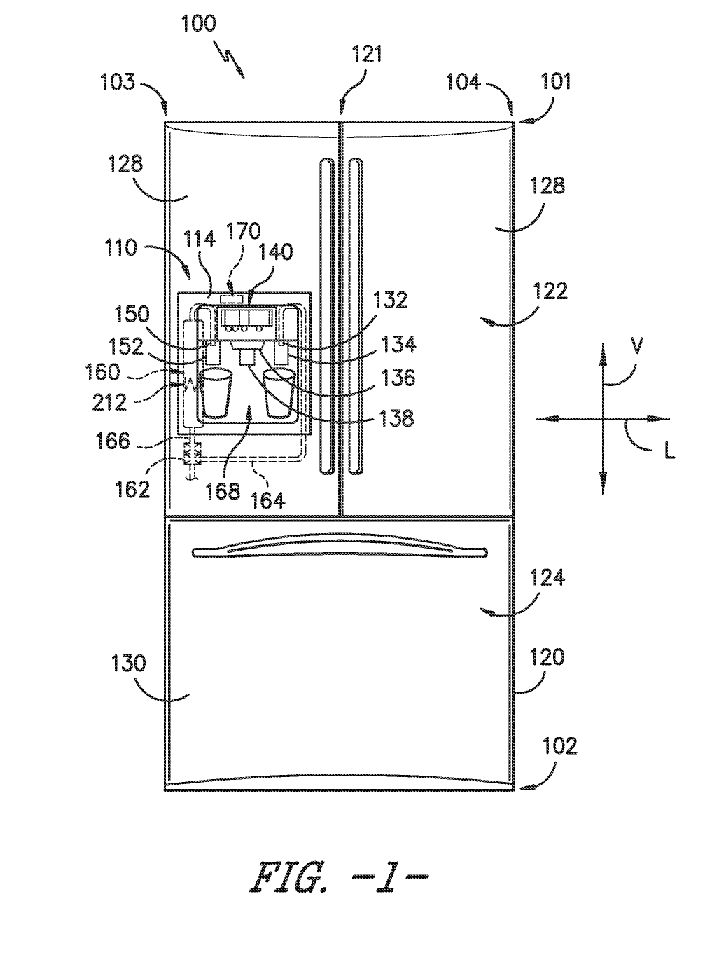

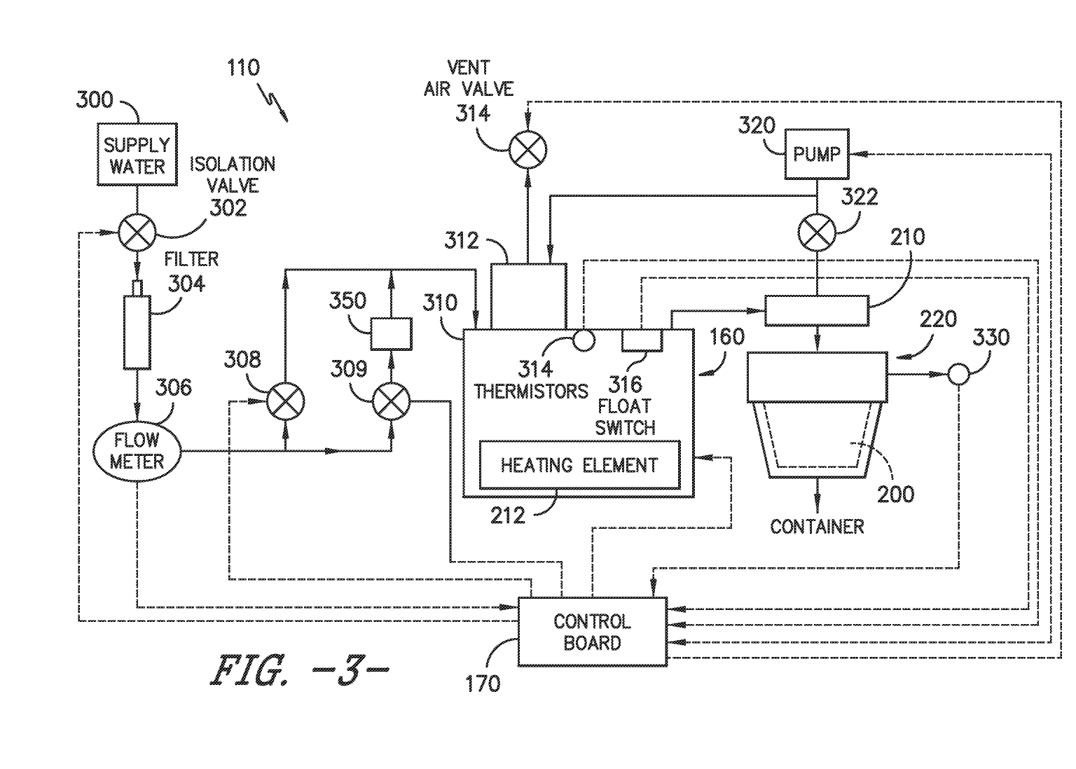

FIG. 1 provides a front, elevation view of a refrigerator appliance 100 according to an exemplary embodiment of the present subject matter. Refrigerator appliance 100 includes a cabinet or housing 120. Housing 120 extends between an upper portion 101 and a lower portion 102 along a vertical direction V and also extends between a first side portion 103 and a second side portion 104 along a lateral direction L. A transverse direction T (see FIGS. 3-6) may additionally be defined perpendicular to the vertical direction and lateral direction L. Housing 120 defines chilled chambers, e.g., a fresh food compartment 122 positioned adjacent upper portion 101 of housing 120 and a freezer compartment 124 arranged at lower portion 102 of housing 120. Housing 120 also defines a mechanical compartment (not shown) for receipt of a sealed cooling system for cooling fresh food compartment 122 and freezer compartment 124.

Refrigerator appliance 100 is generally referred to as a bottom mount or French door refrigerator appliance. However, it should be understood that refrigerator appliance 100 is provided by way of example only. Thus, the present subject matter is not limited to refrigerator appliance 100 and may be utilized in any suitable refrigerator appliance. For example, one of skill in the art will understand that the present subject matter may be used with side-by-side style refrigerator appliances or top mount refrigerator appliances as well.

Refrigerator doors 128 are rotatably hinged to housing 120, e.g., at an opening 121 that permits access to fresh food compartment 122, to permit selective access to fresh food compartment 122. A freezer door 130 is arranged below refrigerator doors 128 for accessing freezer compartment 124. Freezer door 130 is mounted to a freezer drawer (not shown) slidably coupled within freezer compartment 124.

Refrigerator appliance 100 may also include a dispensing assembly 110 for dispensing various fluids, such as liquid water and/or ice to a dispenser recess 168 defined on one of refrigerator doors 128. Dispensing assembly 110 includes a dispenser 114 positioned on an exterior portion of refrigerator appliance 100. Dispenser 114 includes several outlets for accessing ice, chilled liquid water, and heated liquid water. As will be understood by those skilled in the art, liquid water from a water source, such as a well or municipal water system, can contain additional substances or matter. Thus, as used herein, the term “water” includes purified water and solutions or mixtures containing water and, e.g., elements (such as calcium, chlorine, and fluorine), salts, bacteria, nitrates, organics, flavor additives and other chemical compounds or substances.

To access ice, chilled liquid water, and heated liquid water, water-dispensing assembly 110 may for example include a chilled water paddle 134 mounted below a chilled water outlet 132 for accessing chilled liquid water and a heated water paddle 152 mounted below a heated water outlet 150 for accessing heated liquid water. Similarly, an ice paddle 138 is mounted below an ice outlet 136 for accessing ice. As an example, a user can urge a vessel such as a cup against any of chilled water paddle 134, heated water paddle 152, and/or ice paddle 138 to initiate a flow of chilled liquid water, heated liquid water, and/or ice into the vessel within dispenser recess 168, respectively.

A control panel or user interface panel 140 may be provided for controlling the mode of operation of dispenser 114, e.g., for selecting crushed or whole ice. In additional exemplary embodiments, refrigerator appliance 100 may include a single outlet and paddle rather than three separate paddles and dispensers. In such embodiments, user interface panel 140 can include a chilled water dispensing button (not labeled), an ice-dispensing button (not labeled), a heated water dispensing button (not labeled), and a steam-dispensing button (not labeled) for selecting between chilled liquid water, ice, heated liquid water, and steam, respectively.

Outlets 132, 136, and 150 and paddles 134, 138, and 152 may be an external part of dispenser 114, and are positioned at or adjacent dispenser recess 168, e.g., a concave portion defined in an outside surface of refrigerator door 128. Dispenser 114 is positioned at a predetermined elevation convenient for a user to access ice or liquid water, e.g., enabling the user to access ice without the need to bend-over and without the need to access freezer compartment 124. In the exemplary embodiment, dispenser 114 is positioned at a level that approximates the chest level of a user.

Refrigerator appliance 100 may also include features for generating heated liquid water and/or steam and directing such heated liquid water and/or steam to dispenser recess 168. Thus, refrigerator appliance 100 need not be connected to a residential hot water heating system in order to supply heated liquid water and/or steam to dispenser recess 168. In particular, refrigerator appliance 100 includes a water heating assembly 160 mounted within refrigerator door 128 for heating water therein. Refrigerator appliance 100 may include a tee joint 162 for splitting a flow of water. Tee-joint 162 directs water to both a heated water conduit 166 and a chilled water conduit 164.

Heated water conduit 166 is in fluid communication with water heating assembly 160 and heated water outlet 150. Thus, water from tee joint 162 can pass through water heating assembly 160 and exit refrigerator appliance 100 at heated water outlet 150 as heated liquid water or steam. Conversely, chilled water conduit 164 is in fluid communication with chilled water outlet 132. Thus, water from tee-joint 162 can exit refrigerator appliance 100 as chilled liquid water at chilled water outlet 132. In alternative exemplary embodiments, chilled water conduit 164 and heated water conduit 166 are joined such that chilled and heated water conduits 164 and 166 are connected in parallel or in series to each other and dispense fluid at dispenser recess 168 from a common outlet.

Operation of the refrigerator appliance 100 can be regulated by a controller 170 that is operatively coupled to user interface panel 138 and/or various sensors as discussed below. User interface panel 138 provides selections for user manipulation of the operation of refrigerator appliance 100 such as e.g., selections between whole or crushed ice, chilled water, and/or other various options. In response to user manipulation of the user interface panel 138 or sensor signals, controller 170 may operate various components of the refrigerator appliance 100. Controller 170 may include a memory and one or more microprocessors, CPUs or the like, such as general or special purpose microprocessors operable to execute programming instructions or micro-control code associated with operation of refrigerator appliance 100. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 170 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Controller 170 may be positioned in a variety of locations throughout refrigerator appliance 100. In the illustrated embodiment, controller 170 is located within the user interface panel 138. In other embodiments, the controller 170 may be positioned at any suitable location within refrigerator appliance 100, such as for example within a fresh food chamber, a freezer door, etc. Input/output (“I/O”) signals may be routed between controller 170 and various operational components of refrigerator appliance 100. For example, user interface panel 138 may be in communication with controller 170 via one or more signal lines or shared communication busses.

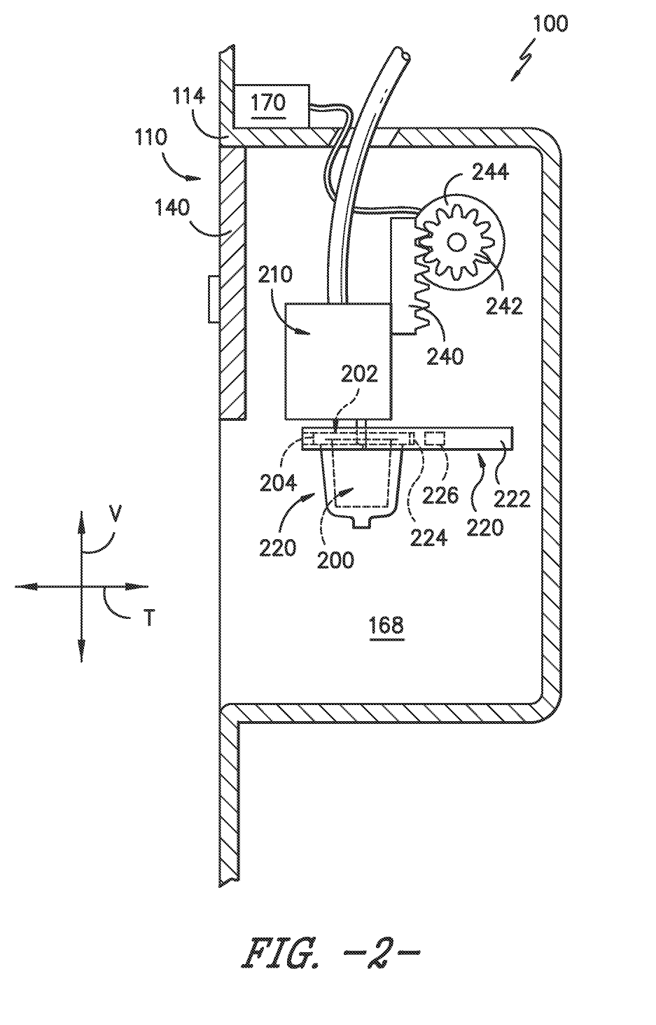

Referring now to FIG. 2, one embodiment of a dispensing assembly 110 is illustrated. As discussed herein, refrigerator appliance 100 may be utilized with single serve flavor pods 200. A single serve flavor pod 200 is generally a container which contains a predetermined amount of a substance to be mixed with a suitable liquid, such as water, etc. For example, coffee, tea, powdered chocolate, lemonade, or other suitable consumable or non-consumable substances may be contained within the flavor pod 200. A top cover 202 may enclose an opening of the container, and may be puncturable and/or removable to access the substance therein. For example, in some embodiments, the top cover 202 may be formed from a suitable foil material, such as aluminum foil. Flavor pod 200 may additionally include a lip 204, which may facilitate placing the flavor pod in a housing, as discussed below, such as by sliding the flavor pod into the housing. A liquid may then be introduced into flavor pod 200, and the liquid and substance may then flow from flavor pod 200 into, for example, a container such as a cup (not shown) typically placed below flavor pod 200.

As shown, a dispensing assembly 110 may include an outlet conduit 210. The outlet conduit 210 may be configured for flowing a fluid therefrom, such as liquid and/or gas. In some embodiments, for example, outlet conduit 210 may be a portion of heated water conduit 166, such as heated water outlet 150, or a portion of chilled water conduit 164, such as chilled water outlet 132. Alternatively, the outlet conduit 210 may be independent from such conduits. The outlet conduit 210 may generally be disposed in the dispenser recess 168, as illustrated.

In exemplary embodiments, the outlet conduit 210 may flow a gas, such as air, therethrough. For example, as discussed herein, air or another suitable gas can pass through a pump and valve to outlet conduit 210, and can then be flowed from outlet conduit 210.

Additionally, the outlet conduit 210 may flow a heated liquid, such as heated water, therethrough. For example, as discussed above, water can pass through a water heating assembly 160 and be heated therein, such that it flows from outlet conduit 210 as heated liquid water or steam. Thus, dispensing assembly 110 may include a heating element 212, which may for example, be disposed in water heating assembly 160 as illustrated, for heating the fluid before the fluid is flowed from the outlet conduit 210.

As further illustrated, a housing 220 may be provided for containing the single serve flavor pod 200. Housing 220 may also be disposed in dispenser recess 168, as shown. Housing 220 may, for example, be received on a platform 222 within dispenser recess 168. Further, housing 220 may define a recess 224 therein, into which a single serve flavor pod 200 may be placed, e.g., a flavor pod 200 may be slid into recess 224 until lip 204 of flavor pod 200 rests on a portion of housing 220 defining an upper portion of recess 224. In some embodiments, various sidewalls may additionally be included in housing 220 to surround flavor pod 200 on various sides. Housing 220 also may be configured for use with other appliances, i.e., for use separately from refrigerator appliance 100.

Additionally, in some embodiments, user interface panel 140 may further define dispenser recess 168. As shown, panel 140 may, for example, extend from dispenser 114, such as in the generally vertical direction V, such that a portion of recess 168 is defined behind panel 140. Additionally, panel 140 may serve to hide various other components, such as outlet conduit 210, housing 220, and/or various components thereof in various positions as discussed herein. For example, from a point-of-view in the transverse direction T, a user may view panel 140 but not be able to see such components hidden behind panel 140 when in various positions, as discussed herein.

In some embodiments, one or both of outlet conduit 210 and housing 220 according to the present disclosure are movable. Specifically, as shown, one or both of outlet conduit 210 and housing 220 may be movable toward (and conversely away from) the other of outlet conduit 210 and housing 220. In exemplary embodiments, such movement of outlet conduit 210 generally may be along the vertical direction V, and such movement of housing 220 generally may be along the transverse direction T. Such movement may facilitate use of single serve flavor pod 200, by allowing flavor pod 200 to be loaded in housing 220 and then provided with fluid from outlet conduit 210. For example, such movement may bring outlet conduit 210 and housing 220 into fluid communication, such that, e.g., fluid may be flowed from outlet conduit 210 into flavor pod 200 as required. In some embodiments, at least a portion of outlet conduit 210 is received in housing 220 such that a seal is formed between outlet conduit 210 and housing 220 to prevent fluid leakage.

FIG. 2 illustrates one embodiment of the present disclosure, wherein outlet conduit 210 is movable along a generally vertical direction V. As shown, outlet conduit 210 in these embodiments may include a rack 240 and a mating pinion gear 242 mounted to a motor 244, which in turn is in communication with a controller 170. Operation of the motor 244 via commands from controller 170 may move outlet conduit 210 as desired. Further, housing 220 may be moved by a user of dispensing assembly 110, e.g., by sliding housing 220 along a generally transverse direction T along rails included in platform 222. In alternative embodiments, both housing 220 and outlet conduit 210 may be movable based on communications with and from controller 170 or based on movement by a user. In addition, it should be understood that the present disclosure is not limited to such rack-and-pinion embodiments; rather, any suitable mechanical apparatus may be utilized to facilitate movement of housing 220 and/or outlet conduit 210.

Thus, controller 170 may be in communication with one or both of outlet conduit 210 and housing 220 and may be operable to move one or both of outlet conduit 210 and housing 220 as desired. For example, in some embodiments, controller 170 may be operable to cause such movement based on a user input, such as via a user interacting with user interface panel 140. Additionally or alternatively, controller 170 may be automatically operable based on sensing of housing 220 supported on, e.g., platform 222. A sensor 226 may be provided for sensing whether housing 220 has been received in or on platform 222. Sensor 226 may, in some embodiments, be included in outlet conduit 210 or housing 220. One or both of outlet conduit 210 and housing may be initially moved away from each other, for example, to allow for loading of a flavor pod 200 in housing 220. When housing 220 is received in platform 222, sensor 226 may detect the presence of housing 220 and communicate this to controller 170, which may instruct one or both of outlet conduit 210 and housing 220 to move toward each other, e.g., to bring outlet conduit 210 and housing 220 into fluid communication. Further, when outlet conduit 210 has completed the fluid flow therethrough into housing 220, controller 170, sensor 226, or another suitable sensor (such as a sensor connected to outlet conduit 210) may detect such completion. This may be communicated to controller 170 and/or controller 170 may instruct one or both of outlet conduit 210 and housing 220 to move away from other, e.g., to allow for removal of flavor pod 200 from housing 220. Alternatively, such various movements may be performed due to a user selecting various user inputs on user interface panel 140, or as described, due to direct user inputs, such as, e.g., a user sliding or placing housing 220 into or onto platform 222.

It should be understood that the various movements of the various components as discussed herein may be performed based on user input and/or performed automatically. For example, all steps may be performed via user input, automatically, or through a combination of user inputs and automatic steps. In one exemplary embodiment, a user input facilitates an initial movement before or after a flavor pod 200 is placed in housing 220, and the remaining movements are performed automatically.

FIG. 3 is a schematic illustration of one embodiment of various components of dispensing assembly 110. As discussed, dispensing assembly 110 may include an outlet conduit 210 through which liquid flows into flavor pod 200. Various additional components may be provided to facilitate the flow of liquid into and through the outlet conduit 210. Such components may variously be disposed in, for example, dispenser 114, a door 128, 130, or another suitable location in refrigerator appliance 100.

As shown, liquid may be supplied from a liquid source 300 through a valve 302, such as an isolation valve, to a filter 304. The liquid may be filtered in filter 304, and then flowed through a flow meter 306. One or more supply valves, such as a first supply valve 308 and a second supply valve 309, may then control flow of the liquid to a fluid heating assembly 160. For example, when actuated to an open position, such as by controller 170, liquid may flow through one or both supply valves 308, 309 to fluid heating assembly 160. The flow rate of the liquid through valves 308, 309 may be the same or a different flow rate; that is, the flow rate through one of valves 308, 309 may be higher than the rate of flow through the other valve.

Liquid may further flow through a flow control device 350. Flow control device 350 is generally upstream of and in fluid communication with outlet conduit 210. In the illustrated exemplary embodiment, liquid is flowed to flow control device 350 after being flowed through second supply valve 309 and before flowing to fluid heating assembly 160. Thus, in some embodiments, flow control device 350 may be upstream of fluid heating assembly 160 and downstream of second supply valve 309. Alternatively, however, flow control device 350 may be downstream of fluid heating assembly 160, upstream of second supply valve 309, and/or at any suitable location within dispensing assembly 110. Additionally, in some embodiments, a second flow control device may be positioned upstream or downstream of first supply valve 308 and/or at any other suitable location within dispensing assembly 110. Without a second flow control device 350 to limit the flow from first supply valve 308, the flow from first supply valve 308 may generally be at a high flow rate and the flow from second supply valve 309 through flow control device 350 may be at a low flow rate.

Flow control device 350 may generally alter various flow characteristics of the liquid flow therethrough, such that liquid output from flow control device 350 is at a generally constant pressure. By supplying liquid therefrom at a generally constant pressure, the back pressure in dispensing assembly 110 is advantageously regulated, such that a flow rate of liquid from outlet conduit 210 into single serve flavor pod 200 is regulated at a generally constant flow rate. Further, advantageously due to use of flow control device 350 in dispensing assembly 110, pumps are not required for flow through outlet conduit 210 into single serve flavor pods 200. Flow control devices 350 are, for example, passive components that operate due to flow characteristics of the liquid flowing therethrough, rather than due to external power sources. In exemplary embodiments, flow control device 350 is a pressure compensation flow control valve. Such valve generally alters an inlet flow at a variable pressure to an outlet flow at a generally constant pressure, thereby providing an outlet flow at a generally constant flow rate, such as, e.g., within approximately 5% of a selected flow rate. Thus, utilizing flow control device 350, liquid from flow control device 350 can be provided at a known, consistent flow rate.

It should be understood that flow control devices 350 are not limited to the above disclosed embodiments. Rather, any suitable apparatus through which liquid at a variable inlet pressure is exhausted at a generally constant outlet pressure is within the scope and spirit of the present disclosure.

Fluid heating assembly 160 may be disposed upstream of outlet conduit 210, such as, e.g., between flow control device 350 and outlet conduit 210. Assembly 160 may, for example, include a holding chamber 310. Holding chamber 310 generally holds liquid for heating and dispensing therefrom. An expansion chamber 312 may be coupled to holding chamber 310, e.g., to allow gas generated due to fluid heating in holding chamber 310 as well as overflow liquid to flow into expansion chamber 312. A vent valve 314 may allow such gas to escape from expansion chamber 312. Holding chamber 310 may additionally include, for example, a thermistor 316 and a float or level switch 318, which may govern the level and supply of liquid.

Further, a gas pump 320 may be provided. Gas pump 320 may be configured to selectively evacuate expansion chamber 312. For example, after liquid is flowed from fluid heating assembly 160, overflow liquid may remain in expansion chamber 312. Gas pump 320 may be operated, such as, e.g., by controller 170, to flow this liquid back into holding chamber 310. Gas pump 320 may supply gas from a suitable gas source, such as the environment when air is utilized, to expansion chamber 312. Additionally, gas pump 320 may selectively flow gas through outlet conduit 210 to a single serve flavor pod 200, such as, e.g., after liquid has been flowed to and through flavor pod 200, to evacuate remaining liquid from flavor pod 200. A gas valve 322 may allow such gas to be provided to outlet conduit 210.

Liquid may thus be provided to outlet conduit 210 via the various other components of dispensing assembly 110. Liquid may be supplied from first supply valve 308 and fluid heating assembly 160 to outlet conduit 210 and into and through single serve flavor pods 200. Alternatively, liquid may be supplied from second supply valve 309, flow control device 350, and fluid heating assembly 160 to outlet conduit 210 and into and through single serve flavor pods 200. Switches 330, which may, e.g., be mounted on platform 222 and/or sensors 226, may be activated by the receipt of housing 220 on or in platform 222 to indicate that a supply of liquid or gas is required.

As illustrated, controller 170 may be in communication with the various components of dispensing assembly 110 and may control operation of the various components. For example, the various valves, switches, etc. may be actuatable based on commands from controller 170. As discussed, interface panel 140 may additionally be in communication with controller 170. Thus, the various operations may occur based on user input or automatically through controller 170 instruction.

As discussed, the use of a flow control device 350 in dispensing assembly 110 provides advantageous flow characteristics to the liquid flowing from outlet conduit 210 into single serve flavor pods 200. For example, because the liquid flowing from flow control device 350 is at a generally constant pressure, a generally constant backpressure is maintained in dispensing assembly 110. To dispense liquid from outlet conduit 210 into single serve flavor pods 200, second supply valve 309 may be actuated to an open position. Liquid then flowing through dispensing assembly 110 downstream of flow control device 350 may have flow characteristics such that the liquid flows from outlet conduit 210 at a generally constant flow rate. Accordingly, contact time for the liquid in single serve flavor pods 200 may be predictable and may result in increases in single serve beverage quality.

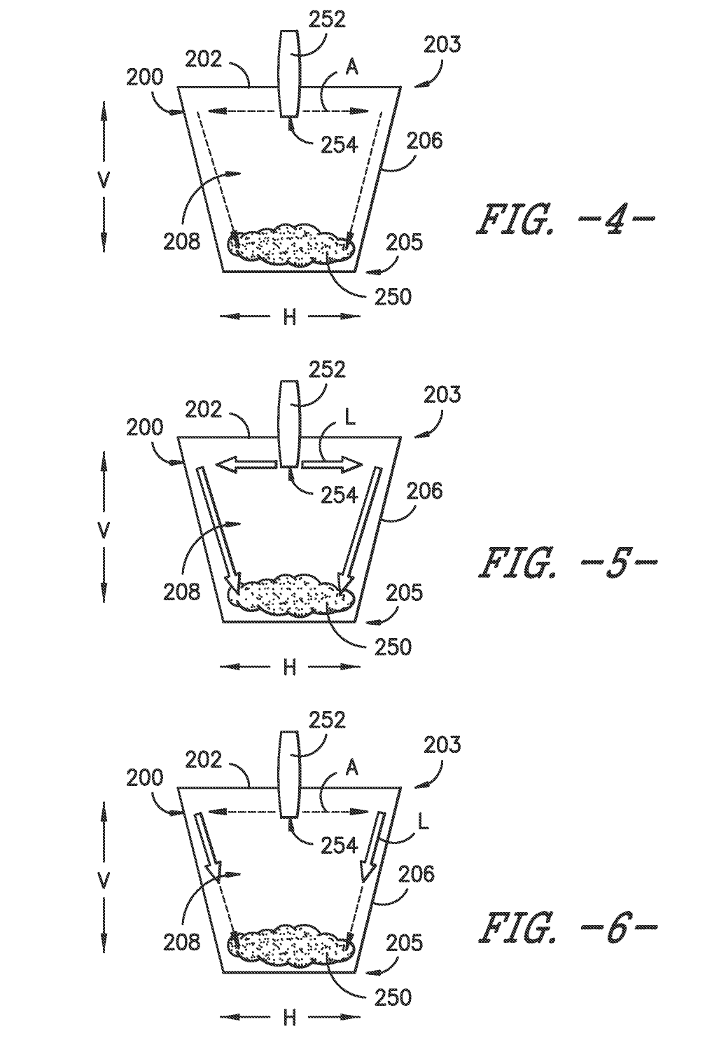

Referring now to FIGS. 4, 5, and 6, single serve flavor pod 200 includes a sidewall 206 extending between a top portion 203 and a bottom portion 205 of flavor pod 200. Top portion 203 may include top cover 202, and top portion 203, bottom portion 205, and sidewall 206 define a cavity 208 for containing a substance 250. As previously described, substance 250 may include, e.g., coffee, tea, powdered chocolate, powdered lemonade, or the like.

A needle 252 may provide one or more fluids to single serve flavor pod 200 to mix with substance 250 contained within pod 200 and to flow the mixture of substance 250 and the fluid to, e.g., a container placed below flavor pod 200 within dispenser recess 168. Needles 252 may be provided in, e.g., housing 220. In some embodiments, needle 252 may puncture top cover 202 of single serve flavor pod 200 such that a tip 254 of needle 252 is positioned within cavity 208. In other embodiments, tip 254 may be positioned within flavor pod 200 through an opening in top cover 202 created by another component of refrigerator appliance 100, or needle 252 may provide fluids to single serve flavor pod 200 without tip 254 or any portion of needle 252 positioned within cavity 208 of flavor pod 200.

Needle 252 may provide or deliver fluids such as, e.g., air or liquid water to flavor pod 200 near a top portion 203 of flavor pod 200. Air may be provided from, e.g., gas pump 320, and water may be provided from, e.g., liquid source 300 through supply valves 308, 309. In some embodiments, the water may be heated, e.g., using fluid heating assembly 160, before being flowed to single serve flavor pod 200. Other types of fluids and sources for providing fluids to needle 252 may also be used.

As shown in FIGS. 4, 5, and 5, needle 252 may provide fluid to flavor pod 200 such that the fluid flows in a substantially horizontal direction H upon exiting needle 252, i.e., in a direction substantially parallel to top portion 203 and a bottom portion 205 of single serve flavor pod 200. The fluid may then flow toward bottom portion 205 generally along a sidewall 206 extending between top portion 203 and bottom portion 205 of flavor pod 200. The fluid may then mix with substance 250 contained within single serve flavor pod 200, e.g., to create a beverage that is dispensed to a container placed beneath flavor pod 200.

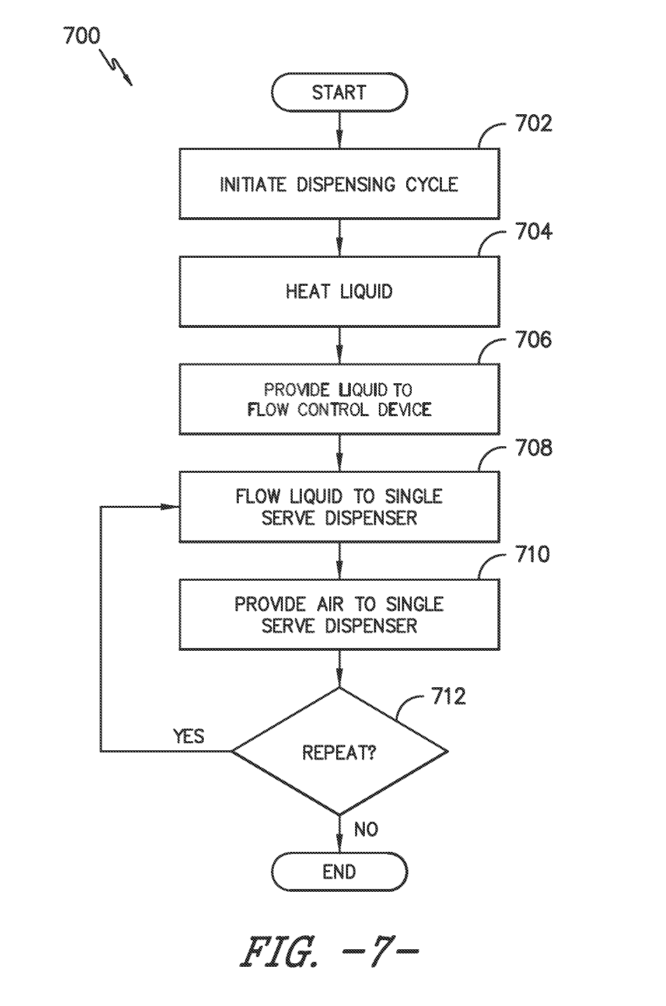

A variety of methods may be used to provide fluid to flavor pod 200 to properly dissolve or mix with substance 250. Referring to FIGS. 4 and 5, in some embodiments, a flow of air A and a flow of liquid L may be provided alternately to cavity 208 to dissolve and/or mix with substance 250. In other embodiments, a flow of liquid L may be provided to cavity 208, then the flow of liquid L may be paused for a period of time t_{pause,} and the flow of liquid L to cavity 208 may resume after the period of time tₚₐᵤₛₑ has expired. Referring now to FIG. 6, in still other embodiments, a flow of air A and a flow of liquid L may be provided simultaneously to cavity 208. Other methods of providing fluid to single serve flavor pod 200 may be used as well.

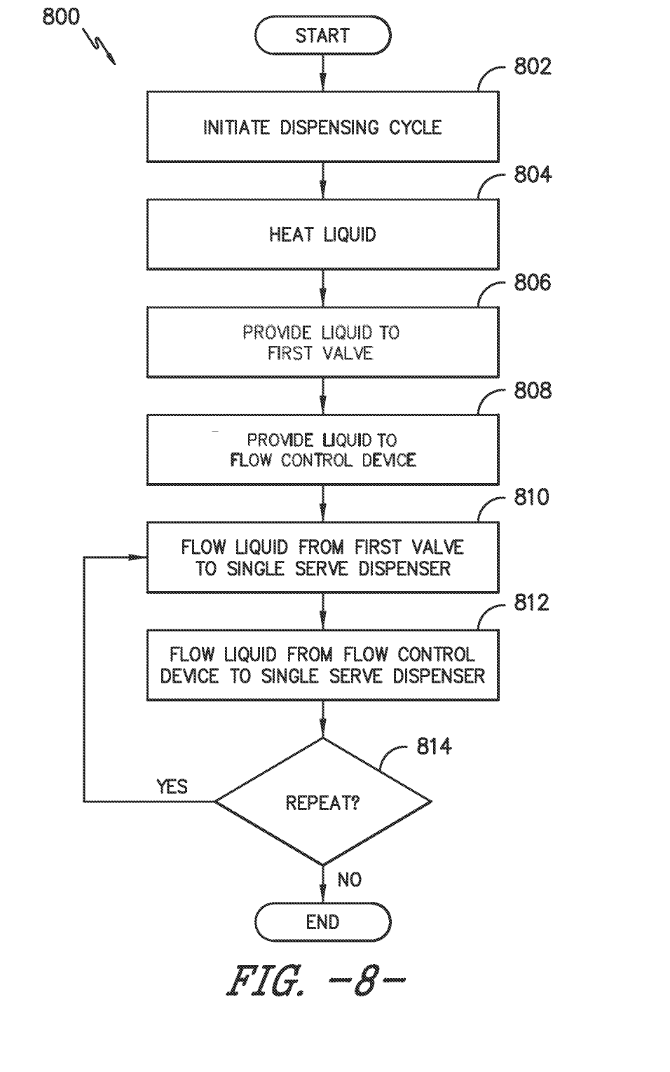

FIG. 7 illustrates an exemplary method 700 of operating refrigerator appliance 100. Method 700 may be performed in whole or in part by controller 170 or any other suitable device or devices. At step 702, a dispensing cycle is initiated. The dispensing cycle may be initiated, e.g., when sensor 226 senses that housing 220, containing a single serve flavor pod 200, has been received on or in platform 222. Alternatively, the dispensing cycle may be initiated upon detecting one or more inputs by a user of refrigerator appliance 100. Other inputs and/or signals may also be used to indicate a dispensing cycle should be initiated.

At step 704, liquid is heated using, e.g., fluid heating assembly 160. The liquid may be, e.g., liquid water or any other appropriate liquid. In some embodiments, step 704 may be omitted such that the liquid is not heated. At step 706, the liquid is provided to, e.g., second supply valve 309 and flow control device 350.

Next, the liquid is flowed to housing 220 and single serve flavor pod 200 at step 708. For example, second supply valve 309 is actuated to an open position such that the liquid flows through second supply valve 309 and flow control device 350 to outlet conduit 210 and, from outlet conduit 210, into and through single serve flavor pod 200. At step 710, a flow of air or other appropriate gas is provided to single serve flavor pod 200, e.g., from gas pump 320. In some embodiments, steps 708 and 710, i.e., flowing the liquid and providing the air flow, may be successively alternated during the remainder of the dispensing cycle. Such embodiments may include step 712 of determining whether to repeat the steps of flowing the liquid and providing the flow of air. Alternatively, step 712 may be omitted, and steps 708 and 710 automatically may be successively repeated until the dispensing cycle ends, i.e., until the required amount of liquid to create the beverage has been dispensed. In other embodiments, steps 708 and 710 of flowing the liquid and providing the air flow may be performed simultaneously. That is, the liquid may be flowed to single serve flavor pod 200 as a flow of air is provided to single serve flavor pod 200. By flowing the liquid and providing the air flow to flavor pod 200, either simultaneously or alternately, substance 250 contained within flavor pod 200 is sufficiently wetted or soaked with the liquid to create the beverage.

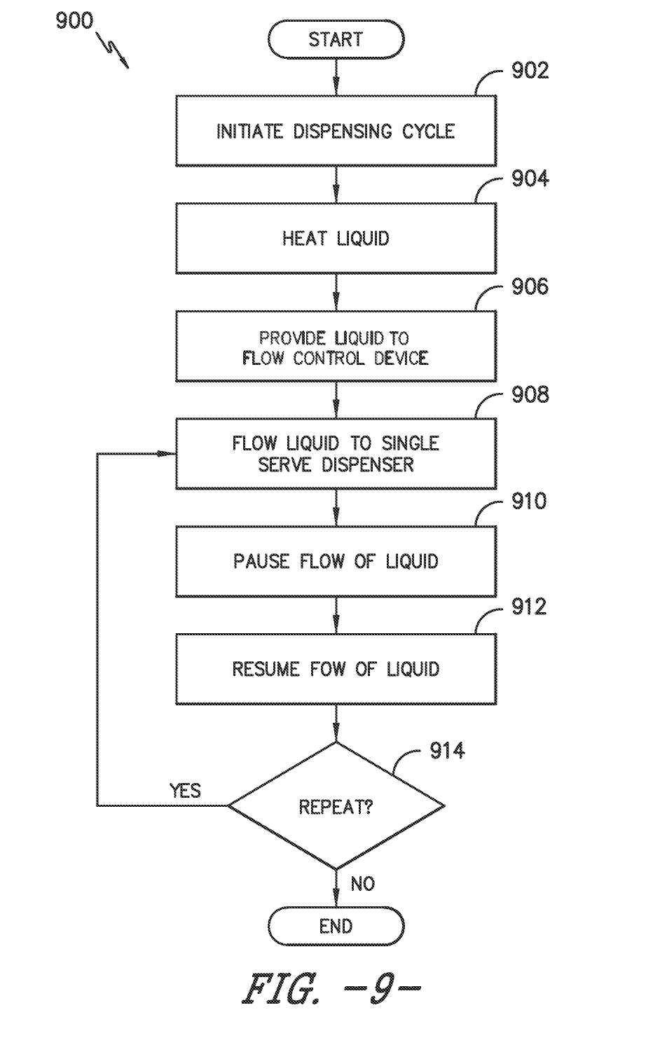

FIG. 8 illustrates an exemplary method 800 of operating refrigerator appliance 100. Method 800 may be performed in whole or in part by controller 170 or any other suitable device or devices. At step 802, a dispensing cycle is initiated. The dispensing may be initiated, e.g., when sensor 226 senses that housing 220, containing a single serve flavor pod 200, has been received in or on platform 222. Alternatively, the dispensing cycle may be initiated upon detecting one or more inputs by a user of refrigerator appliance 100. Other inputs and/or signals may also be used to indicate a dispensing cycle should be initiated.

At step 804, liquid is heated using, e.g., fluid heating assembly 160. The liquid may be, e.g., liquid water or any other appropriate liquid. In some embodiments, step 804 may be omitted such that the liquid from either valve is not heated. At step 806, liquid is provided to, e.g., first supply valve 308. At step 808, the liquid is provided to, e.g., second supply valve 309 and flow control device 350.

Next, at step 810, the liquid is flowed from first supply valve 308 to housing 220 and single serve flavor pod 200. For example, first supply valve 308 is actuated to an open position such that the liquid flows through first supply valve 308 to outlet conduit 210 and, from outlet conduit 210, into and through single serve flavor pod 200. At step 812, the liquid is flowed from flow control device 350 to housing 220 and single serve flavor pod 200. For example, second supply valve 309 is actuated to an open position such that the liquid flows through second supply valve 309 and flow control device 350 to outlet conduit 210 and, from outlet conduit 210, into and through flavor pod 200. In some embodiments, steps 810 and 812, i.e., flowing the liquid from first supply valve 308 and flowing the liquid from flow control device 350, may be successively alternated during the remainder of the dispensing cycle. Such embodiments may include step 814 of determining whether to repeat the steps of flowing the liquid. Alternatively, step 814 may be omitted, and steps 810 and 812 automatically may be successively repeated until the dispensing cycle ends, i.e., until the required amount of liquid to create the beverage has been dispensed. In other embodiments, steps 810 and 812 of flowing the liquid may be performed simultaneously. That is, the liquid may be flowed from first supply valve 308 to single serve flavor pod 200 as the liquid is flowed from flow control device 350 to single serve flavor pod 200.

Further, in still other embodiments, step 810 may last a set period of time t_{liquid1} and step 812 may last a set period of time t_{liquid2}, i.e., liquid may flow from first supply valve 308 for time t_{liquid1} and liquid may flow from flow control device 350 for time t_{liquid2}. Time t_{liquid1} may be less than time t_{liquid2} such that liquid is flowed from first supply valve 308 for a shorter period of time than liquid is flowed from flow control device 250. That is, the dispense time from first supply valve 308, having a high flow rate, may be limited. By flowing the liquid to flavor pod 200 from each supply valve 308, 309, i.e., from first supply valve 208 and from flow control device 350, either simultaneously or alternately, substance 250 contained within flavor pod 200 is sufficiently wetted or soaked with the liquid to create the beverage.

FIG. 9 illustrates an exemplary method 900 of operating refrigerator appliance 100. Method 900 may be performed in whole or in part by controller 170 or any other suitable device or devices. At step 902, a dispensing cycle is initiated. The dispensing may be initiated, e.g., when sensor 226 senses that housing 220, containing a single serve flavor pod 200, has been received in or on platform 222. Alternatively, the dispensing cycle may be initiated upon detecting one or more inputs by a user of refrigerator appliance 100. Other inputs and/or signals may also be used to indicate a dispensing cycle should be initiated.

At step 904, liquid is heated using, e.g., fluid heating assembly 160. The liquid may be, e.g., liquid water or any other appropriate liquid. In some embodiments, step 904 may be omitted such that the liquid is not heated. At step 906, the liquid is provided to, e.g., second supply valve 309 and flow control device 350.

Next, the liquid is flowed to single serve flavor pod 200 at step 908. For example, second supply valve 309 is actuated to an open position such that the liquid flows through second supply valve 309 and flow control device 350 to outlet conduit 210 and, from outlet conduit 210, into and through single serve flavor pod 200. At step 910, the flow of liquid is paused for a predetermined period of time tₚₐᵤₛₑ. Time tₚₐᵤₛₑ may be selected based on, e.g., an input, such as a desired beverage size, by a user of refrigerator appliance 100; the total time required for the dispensing cycle; or any other appropriate criterion or combination of criteria. In an exemplary embodiment, time tₚₐᵤₛₑ may be about two seconds, but other values for time tₚₐᵤₛₑ may be used as well.

After time tₚₐᵤₛₑ has elapsed, liquid flow to single serve flavor pod 200 is resumed at step 912. In some embodiments, steps 908, 910, and 912, i.e., flowing the liquid, pausing the flow, and resuming the flow, may be successively alternated during the remainder of the dispensing cycle. Such embodiments may include step 914 of determining whether to repeat the steps of flowing the liquid and providing the flow of air. Alternatively, step 914 may be omitted, and steps 908, 910, 912 automatically may be successively repeated until the dispensing cycle ends, i.e., until the required amount of liquid to create the beverage has been dispensed. By flowing the liquid, pausing the flow, and then resuming the flow of liquid to flavor pod 200, either successively or only once during the dispensing cycle, substance 250 contained within flavor pod 200 is sufficiently wetted or soaked with the liquid to create the beverage.

Other methods of operating refrigerator appliance 100 may also be used. For example, in some embodiments of the above-described methods, during the steps of providing fluid to flavor pod 200, fluid may be flowed from first supply valve 308, second supply valve 309 and flow control device 350, and gas pump 320 either successively or simultaneously. Utilizing any of the above or similar methods, substance 250 within a single serve flavor pod 200 can be sufficiently dissolved in a solution and flushed out of flavor pod 200, without knowing the identity of the substance. That is, for the substantially horizontal fluid flow path from needle 252 described above, for substances 250 such as, e.g., coffee, fluid can evenly contact the coffee grounds contained within a flavor pod 200 near top portion 203 for an ideal period of time, which can improve overall coffee quality. In addition, for substances 250 such as, e.g., powdered chocolate or lemonade contained within a flavor pod 200 near bottom portion 205, alternating flowing liquid and providing air to flavor pod 200 disrupts the laminar tendency of continuously dispensing liquid to improve the mixing of the liquid and substance 250 and better dissolve substance 250. Further, providing a flow of air simultaneously with flowing the liquid increases the exit velocity of the liquid from needle 252, which can increase splashing against sidewall 206 of flavor pod 200 and thereby increase mixing with substance 250 contained near bottom portion 205. Moreover, by alternating flowing liquid from first supply valve 308 and second supply valve 309, through flow control device 250, turbulence can be created within cavity 208 of flavor pod 200 to improve mixing when a flavor pod 200 with substance 250 contained near bottom portion 205 is used but not to impact contact time when a flavor pod 200 with a substance 250 such as coffee grounds is used. Accordingly, using one or more of the exemplary steps or methods described above, the flow of fluid required to create a beverage from a variety of substances 250 that may be contained in a single serve flavor pod 200 can be optimized such that the flow does not depend on substance 250 and such that substance 250 is sufficiently wetted or soaked to create the beverage. That is, substance 250 is soaked with the liquid provided to single serve flavor pod 200, e.g., without overextracting coffee grounds or leaving behind powdered chocolate or lemonade in flavor pod 200, to create the beverage.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. A method for operating a refrigerator appliance, the refrigerator appliance including a dispensing assembly for receipt of a housing for containing single serve flavor pods, each single serve flavor pod containing a substance for creating a beverage, the method comprising the steps of:
initiating a dispensing cycle;
providing a liquid to a supply valve and a flow control device such that the liquid is output from the flow control device at a known flow rate;
flowing the liquid from the flow control device to the single serve flavor pod; and
providing a flow of air to the single serve flavor pod,
wherein flowing the liquid and providing the flow of air soaks the substance in the single serve flavor pod with the liquid to create the beverage.

2. The method of claim 1, wherein the steps of flowing the liquid and providing the flow of air are successively alternated during the dispensing cycle.

3. The method of claim 1, wherein the steps of flowing the liquid and providing the flow of air are performed simultaneously.

4. The method of claim 1, further comprising the step of determining whether the steps of flowing the liquid and providing the flow of air should be repeated.

5. The method of claim 1, further comprising the step of heating the liquid.

6. The method of claim 5, wherein the liquid is heated at a location downstream of the flow control device.

7. A method for operating a refrigerator appliance, the refrigerator appliance including a dispensing assembly for receipt of a housing for containing single serve flavor pods, each single serve flavor pod containing a substance for creating a beverage, the method comprising the steps of:
initiating a dispensing cycle;
providing a liquid to a first supply valve;
providing the liquid to a second supply valve and a flow control device such that the liquid is output from the flow control device at a known flow rate;
flowing the liquid from the first supply valve to the single serve flavor pod; and
flowing the liquid from the flow control device to the single serve flavor pod,
wherein flowing the liquid from the first supply valve and from the flow control device soaks the substance in the single serve flavor pod with the liquid to create the beverage.

8. The method of claim 7, wherein the steps of flowing the liquid from the first supply valve and flowing the liquid from the flow control device are successively alternated during the dispensing cycle.

9. The method of claim 7, wherein the steps of flowing the liquid from the first supply valve and flowing the liquid from the flow control device are performed simultaneously.

10. The method of claim 7, further comprising the step of determining whether the steps of flowing the liquid from the first supply valve and flowing the liquid from the flow control device should be repeated.

11. The method of claim 7, wherein the liquid is flowed from the first supply valve for a time t_{liquid1} and the liquid is flowed from the flow control device for a time t_{liquid2}, and wherein time t_{liquid2} is greater than time t_{liquid1}.

12. The method of claim 7, further comprising the step of heating the liquid.

13. The method of claim 12, further comprising the step of heating the liquid downstream of the flow control device.

14. A method for operating a refrigerator appliance, the refrigerator appliance including a dispensing assembly for receipt of a housing for containing single serve flavor pods, each single serve flavor pod containing a substance for creating a beverage, the method comprising the steps of:
initiating a dispensing cycle;
providing a liquid to a supply valve and a flow control device such that the liquid is output from the flow control device at a known flow rate;
flowing the liquid from the flow control device to the single serve flavor pod;
pausing the flow of the liquid for a predetermined time period tₚₐᵤₛₑ; and
resuming the flow of liquid from the flow control device to the single serve flavor pod,
wherein flowing the liquid from the flow control device, pausing the flow, and resuming the flow soaks the substance in the single serve flavor pod with the liquid to create the beverage.

15. The method of claim 14, wherein the steps of flowing, pausing, and resuming are successively alternated during the dispensing cycle.

16. The method of claim 14, further comprising the step of determining whether the steps of flowing, pausing, and resuming should be repeated.

17. The method of claim 14, further comprising the step of heating the liquid.

18. The method of claim 17, wherein the liquid is heated at a location downstream of the flow control device.

19. The method of claim 13, further comprising the step of selecting the predetermined time interval tₚₐᵤₛₑ.
